(19) United States
(12) Patent Application Publication
(10) Pub. No.: US 2011/0093203 A1
(43) Pub. Date: Apr. 21, 2011

(54) SYSTEM AND METHOD FOR CLUSTERING ARRIVALS OF SEISMIC ENERGY TO ENHANCE SUBSURFACE IMAGING

(75) Inventors: Yue Wang, Danville, CA (US); Norman Ross Hill, Houston, TX (US)

(73) Assignee: Chevron U.S.A. Inc.

(21) Appl. No.: 12/582,902

(22) Filed: Oct. 21, 2009

(51) Int. Cl. G01V 1/28; G01V 1/34

(52) U.S. Cl. 702/16

(57) ABSTRACT

Seismic data acquired at or near a geologic volume of interest is processed. This may include forming an image of the geologic volume of interest from the seismic data. The seismic data may be processed by aggregating energy arrivals to reduce the number of imaging processes that must be performed to determine an image of the geologic volume of interest. This aggregation may be based on groupings of energy arrivals referred to herein as clusters.

### FIELD OF THE INVENTION

The invention relates to processing seismic data acquired at or near a geologic volume of interest to from an image of the geologic volume of interest.

### BACKGROUND OF THE INVENTION

Techniques for imaging a geologic volume of interest from seismic data acquired at or near the geologic volume of interest are known. In some conventional techniques, arrivals of seismic energy are modeled as beams, and then the individual beams are used to distribute image data from coarse meshpoints within the geologic volume of interest to surrounding fine meshpoints. In these techniques, a separate imaging process for extending image data from a given coarse meshpoint is required for each of the modeled arrivals at the given coarse meshpoint. This may result in imaging techniques that are costly from an information processing standpoint.

In some conventional techniques, rather than perform separate imaging processes for a plurality of arrivals at a given coarse meshpoint, a single arrival at the given coarse meshpoint may be selected and processed. While this reduces the processing costs associated with the imaging, the accuracy and/or precision of the imaging may suffer.

### SUMMARY OF THE INVENTION

One aspect of the invention relates to a system configured to process seismic data associated with a geologic volume of interest. In one embodiment, the system comprises electronic storage and one or more processors. The electronic storage is configured to store information representative of seismic energy propagated through the geologic volume of interest from one or more energy sources to one or more energy receivers at or near the geologic volume of interest. The one or more processors configured to execute a plurality of computer program modules. The computer program modules comprise an arrival module, a cluster module, an aggregation module, and an image module. The arrival module is configured to obtain one or more parameters of a plurality of arrivals of seismic energy at coarse meshpoints located within the geologic volume of interest, such that for individual coarse meshpoints, parameters for corresponding sets of arrivals of seismic energy are obtained. The coarse meshpoints within the geologic volume of interest comprise a first meshpoint, and the arrival module is configured to obtain one or more parameters for arrivals of seismic energy at the first meshpoint. The cluster module is configured to group arrivals of seismic energy at the coarse meshpoints into clusters of arrivals for the coarse meshpoints. The clusters of arrivals include a first cluster of arrivals including one or more of the arrivals of seismic energy at the first meshpoint, and a second cluster of arrivals including one or more of the arrivals of seismic energy at the first meshpoint. The aggregation module is configured to determine aggregated data for individual ones of the clusters of arrivals such that the aggregated data for the first cluster of arrivals reflects parameters of each of the arrivals of seismic energy at the first meshpoint included in the first cluster of arrivals, and such that the aggregated data for the second cluster of arrivals reflects parameters of each of the arrivals of seismic energy at the first meshpoint included in the second cluster of arrivals. The image module is configured to implement the aggregated data for the clusters of arrivals to image the geologic volume of interest at fine meshpoints surrounding the coarse meshpoints. The image module is configured to implement the aggregated data for the first cluster of arrivals and the aggregated data for the second cluster of arrivals to image the geologic volume of interest at fine meshpoints surrounding the first meshpoint.

Another aspect of the invention relates to a computer-implemented method of processing seismic data associated with a geologic volume of interest, wherein the method is implemented in a computer system comprising one or more processors configured to execute one or more computer program modules. In one embodiment, the method comprises storing, to electronic storage accessible to the one or more processors, information representative of seismic energy propagated through the geologic volume of interest from one or more energy sources to one or more energy receivers at or near the geologic volume of interest; obtaining, on the one or more processors, one or more parameters of a plurality of arrivals of seismic energy at coarse meshpoints located within the geologic volume of interest, such that for individual coarse meshpoints, parameters for corresponding sets of arrivals of seismic energy are obtained, wherein the coarse meshpoints within the geologic volume of interest comprise a first meshpoint, and wherein one or more parameters for arrivals of seismic energy at the first meshpoint are obtained; grouping, on the one or more processors, arrivals of seismic energy at the coarse meshpoints into clusters of arrivals for the coarse meshpoints, wherein the clusters of arrivals include a first cluster of arrivals including one or more of the arrivals of seismic energy at the first meshpoint, and a second cluster of arrivals including one or more of the arrivals of seismic energy at the first meshpoint; determining, on the one or more processors, aggregated data for individual ones of the clusters of arrivals such that the aggregated data for the first cluster of arrivals reflects parameters of each of the arrivals of seismic energy at the first meshpoint included in the first cluster of arrivals, and such that the aggregated data for the second cluster of arrivals reflects parameters of each of the arrivals of seismic energy at the first meshpoint included in the second cluster of arrivals; and implementing, on the one or more processors, the aggregated data for the clusters of arrivals to image the geologic volume of interest at fine meshpoints surrounding the coarse meshpoints, wherein the aggregated data for the first cluster of arrivals and the aggregated data for the second cluster of arrivals are implemented to image the geologic volume of interest at fine meshpoints surrounding the first meshpoint.

Yet another aspect of the invention relates to a computer-implemented method of processing seismic data associated with a geologic volume of interest, wherein the method is implemented in a computer system comprising one or more processors configured to execute one or more computer program modules. In one embodiment, the method comprises storing, to electronic storage accessible to the one or more processors, information representative of seismic energy propagated through the geologic volume of interest from one or more energy sources to one or more energy receivers at or near the geologic volume of interest; obtaining, on the one or more processors, one or more parameters of a plurality of arrivals of seismic energy at coarse meshpoints located within the geologic volume of interest, such that for individual coarse meshpoints parameters for corresponding sets of arrivals of seismic energy are obtained, wherein the coarse meshpoints within the geologic volume of interest comprise a first meshpoint and a second meshpoint, wherein one or more parameters for arrivals of seismic energy at the first meshpoint are obtained, and wherein one or more parameters for arrivals of seismic energy at the second meshpoint are obtained; determining, on the one or more processors, aggregated data for arrivals at the coarse meshpoints such that the aggregated data for the arrivals of seismic energy at the first meshpoint reflects the parameters of each of the arrivals of seismic energy at the first meshpoint, and such that the aggregated data for the arrivals of seismic energy at the second meshpoint reflects the parameters of each of the arrivals of seismic energy at the second meshpoint; and implementing, on the one or more processors, the aggregated data for the clusters of arrivals to image the geologic volume of interest at fine meshpoints surrounding the coarse meshpoints, wherein the aggregated data for the arrivals of seismic energy at the first meshpoint are implemented to image the geologic volume of interest at fine meshpoints surrounding the first meshpoint, and wherein the aggregated data for the arrivals of seismic energy at the second meshpoint are implemented to image the geologic volume of interest at fine meshpoints surrounding the second meshpoint.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to process seismic data, according to one or more embodiments of the invention.

FIG. 2 illustrates arrivals of seismic energy at a meshpoint within a geologic volume of interest, in accordance with one or more embodiments of the invention.

FIG. 3 illustrates an arrival of seismic energy at a meshpoint within a geologic volume of interest, according to one or more embodiments of the invention.

FIG. 4 illustrates a method of processing seismic data, in accordance with one or more embodiments of the invention.

FIG. 5 illustrates a method of processing seismic data, in accordance with one or more embodiments of the invention.

FIG. 6 illustrates a method of processing seismic data, in accordance with one or more embodiments of the invention.

### DETAILED DESCRIPTION OF THE INVENTION

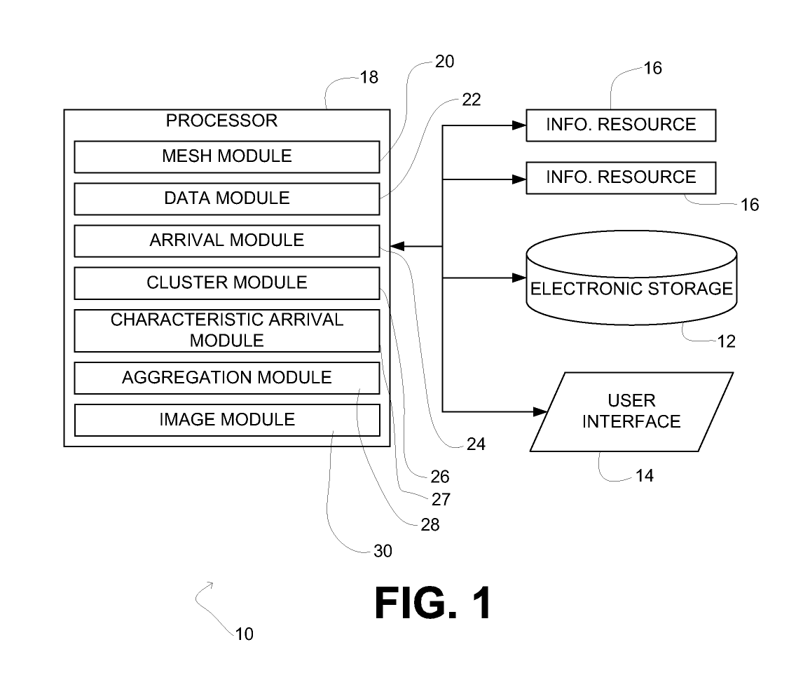

FIG. 1 illustrates a system 10 configured to process seismic data acquired at or near a geologic volume of interest. This may include forming an image of the geologic volume of interest from the seismic data. System 10 processes the seismic data by aggregating energy arrivals to reduce the number of imaging processes that must be performed to determine an image of the geologic volume of interest. This aggregation may be based on groupings of energy arrivals referred to herein as clusters. In one embodiment, system 10 comprises electronic storage 12, a user interface 14, one or more information resources 16, one or more processors 18, and/or other components. In one embodiment, electronic storage 12 comprises electronic storage media that electronically stores information. The electronic storage media of electronic storage 12 may include one or both of system storage that is provided integrally (i.e., substantially non-removable) with system 10 and/or removable storage that is removably connectable to system 10 via, for example, a port (e.g., a USB port, a firewire port, etc.) or a drive (e.g., a disk drive, etc.). Electronic storage 12 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 12 may store software algorithms, information determined by processor 18, information received via user interface 14, information received from information resources 16, and/or other information that enables system 10 to function properly. Electronic storage 12 may be a separate component within system 10, or electronic storage 12 may be provided integrally with one or more other components of system 10 (e.g., processor 18).

User interface 14 is configured to provide an interface between system 10 and a user through which the user may provide information to and receive information from system 10. This enables data, results, and/or instructions and any other communicable items, collectively referred to as “information,” to be communicated between the user and the system 10. As used herein, the term “user” may refer to a single individual or a group of individuals who may be working in coordination. Examples of interface devices suitable for inclusion in user interface 14 include a keypad, buttons, switches, a keyboard, knobs, levers, a display screen, a touch screen, speakers, a microphone, an indicator light, an audible alarm, and a printer. In one embodiment, user interface 14 actually includes a plurality of separate interfaces.

It is to be understood that other communication techniques, either hard-wired or wireless, are also contemplated by the present invention as user interface 14. For example, the present invention contemplates that user interface 14 may be integrated with a removable storage interface provided by electronic storage 12. In this example, information may be loaded into system 10 from removable storage (e.g., a smart card, a flash drive, a removable disk, etc.) that enables the user(s) to customize the implementation of system 10. Other exemplary input devices and techniques adapted for use with system 10 as user interface 14 include, but are not limited to, an RS-232 port, RF link, an IR link, modem (telephone, cable or other). In short, any technique for communicating information with system 10 is contemplated by the present invention as user interface 14.

The information resources 16 include one or more sources of information related to the geologic volume of interest and/or the process of generating an image of the geologic volume of interest. By way of non-limiting example, one of information resources 16 may include seismic data acquired at or near the geologic volume of interest, information derived therefrom, and/or information related to the acquisition. The seismic data may include individual traces of seismic data, or the data recorded on one channel of seismic energy propagating through the geologic volume of interest from a source. The information derived from the seismic data may include, for example, a velocity model, beam parameters associated with beams used to model the propagation of seismic energy through the geologic volume of interest, Green's functions associated with beams used to model the propagation of seismic energy through the geologic volume of interest, and/or other information. Information related to the acquisition of seismic data may include, for example, data related to the position and/or orientation of a source of seismic energy, the positions and/or orientations of one or more detectors of seismic energy, a time at which energy was generated by the source and directed into the geologic volume of interest, and/or other information.

Processor 18 is configured to provide information processing capabilities in system 10. As such, processor 18 may include one or more of a digital processor, an analog processor, a digital circuit designed to process information, an analog circuit designed to process information, a state machine, and/or other mechanisms for electronically processing information. Although processor 18 is shown in FIG. 1 as a single entity, this is for illustrative purposes only. In some implementations, processor 18 may include a plurality of processing units. These processing units may be physically located within the same device or computing platform, or processor 18 may represent processing functionality of a plurality of devices operating in coordination.

As is shown in FIG. 1, processor 18 may be configured to execute one or more computer program modules. The one or more computer program modules may include one or more of a mesh module 20, a data module 22, an arrival module 24, a cluster module 26, a characteristic arrival module 27, an aggregation module 28, an image module 30, and/or other modules. Processor 18 may be configured to execute modules 20, 22, 24, 26, 27, 28, and/or 30 by software; hardware; firmware; some combination of software, hardware, and/or firmware; and/or other mechanisms for configuring processing capabilities on processor 18.

It should be appreciated that although modules 20, 22, 24, 26, 27, 28, and 30 are illustrated in FIG. 1 as being co-located within a single processing unit, in implementations in which processor 18 includes multiple processing units, one or more of modules 20, 22, 24, 26, 27, 28, and/or 30 may be located remotely from the other modules. The description of the functionality provided by the different modules 20, 22, 24, 26, 27, 28, and/or 30 described below is for illustrative purposes, and is not intended to be limiting, as any of modules 20, 22, 24, 26, 27, 28, and/or 30 may provide more or less functionality than is described. For example, one or more of modules 20, 22, 24, 26, 27, 28, and/or 30 may be eliminated, and some or all of its functionality may be provided by other ones of modules 20, 22, 24, 26, 27, 28, and/or 30. As another example, processor 18 may be configured to execute one or more additional modules that may perform some or all of the functionality attributed below to one of modules 20, 22, 24, 26, 27, 28, and/or 30.

The mesh module 20 is configured to obtain the location of a plurality of meshpoints of a mesh through the geologic volume of interest. The mesh and/or the locations of the meshpoints may be stored by mesh module 20 to electronic storage 12. The locations of the meshpoints may be specified by coordinates (e.g., three-dimensional coordinates). In one embodiment, mesh module 20 is configured to generate the mesh by determining the locations of the meshpoints. In one embodiment, mesh module 20 obtains the mesh with the locations of the meshpoints from a source external to processor 18 (e.g., from one of information resources 16, from a user via user interface 14, etc.).

The mesh obtained by mesh module 20 includes coarse meshpoints and fine meshpoints. The coarse meshpoints are distributed through the geologic volume of interest less densely than the fine meshpoints. In one embodiment, the fine meshpoints are distributed at regular intervals between the coarse meshpoints.

The data module 22 is configured to obtain seismic data and information related thereto. The data module 22 obtains such data and information from, for example, one of information resource 16, from a user via user interface 14, and/or from other sources. The seismic data is seismic data that has been acquired at or near the geologic volume of interest. In one embodiment, the obtained seismic data includes individual traces of seismic data recorded during an acquisition of seismic data at or near the geologic volume of interest. The traces of seismic data may be “raw,” or the traces may have been previously processed. For example, the traces of seismic data may have previously been weighted (e.g., Gaussian beam weighted) and/or stacked (e.g., local slant stacked).

The arrival module 24 is configured to obtain arrivals of seismic energy at coarse meshpoints in the mesh through the geologic volume of interest. Obtaining arrivals of seismic energy includes obtaining parameters that describe the propagation of bodies of seismic energy through the meshpoints in the geologic volume of interest during the acquisition of the seismic data. For individual coarse meshpoints, arrival module 24 obtains corresponding sets of arrivals of seismic energy. For example, for a first coarse meshpoint, arrival module 24 obtains parameters that describe a first set of arrivals of bodies of seismic energy at the first coarse meshpoint. The obtained parameters describe each of the arrivals in the first set of arrivals at the first coarse meshpoint individually. For a second meshpoint, arrival module 24 obtains parameters that individually describe a second set of arrivals of seismic energy at the second coarse meshpoint.

In one embodiment, arrival module 24 is configured to determine the arrivals of seismic energy by determining the parameters that describe the propagation of the bodies of seismic energy to the coarse meshpoints. The arrival module 24 may determine the parameters from the seismic data obtained by data module 22. The arrival module 24 may determine the parameters from functions that describe the parameters of the bodies of seismic energy through the geologic volume of interest. For example, the functions may include Green's functions that describe the propagation of the bodies of seismic energy through the geologic volume of interest. The functions may be determined by arrival module 24, or may be obtained by arrival module 24 from an external source (e.g., from information resources 16, from user interface 14, etc.).

In one embodiment, arrival module 24 is configured to obtain the parameters that describe the propagation of the bodies of seismic energy from an external resource that stores or has access to previously determined parameters describing the propagation of the bodies of seismic energy to the coarse meshpoints (e.g., from information resources 16, from user interface 14, etc.).

In one embodiment, the bodies of seismic energy are modeled as beams, such as Gaussian beams. In this embodiment, the parameters obtained by arrival module 24 that describe a given arrival at a given coarse meshpoint may include one or more of central ray path, traveltime (real and/or imaginary), amplitude, phases, beam formation around the central ray path and/or other beam parameters.

The cluster module 26 is configured to form, for the individual coarse meshpoints, sets of one or more clusters of arrivals of seismic energy, where a cluster of arrivals of seismic energy is a grouping of arrivals of seismic energy that have similar properties. For example, a cluster of arrivals of seismic energy at a given coarse meshpoint includes arrivals of seismic energy having parameters that indicate the bodies of seismic energy included in the cluster of arrivals had similar propagation histories (e.g., central ray paths), kinematic and/or dynamic properties, and/or other similar properties.

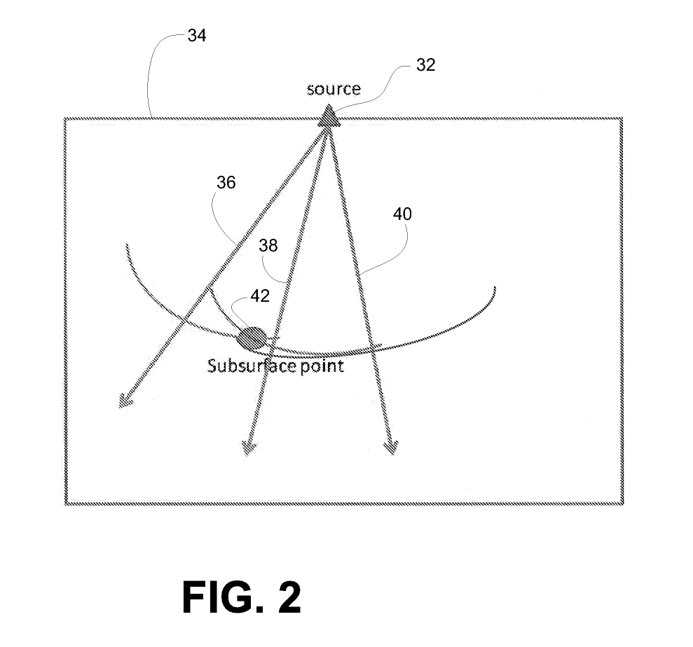

By way of illustration, FIG. 2 illustrates a source 32 that generates seismic energy that propagates through a geologic volume of interest 34. As this seismic energy propagates through geologic volume of interest 34, FIG. 2 shows three bodies of energy 36, 38, and 40 that arrive at a coarse meshpoint 42. Each of bodies of energy 36, 38, and 40 has a similar propagation history (e.g., substantially straight center ray paths). As such, the arrival of each of bodies of energy 36, 38, and 40 may be grouped together into a cluster by a cluster module similar to or the same as cluster module 26 (shown in FIG. 1 and described herein).

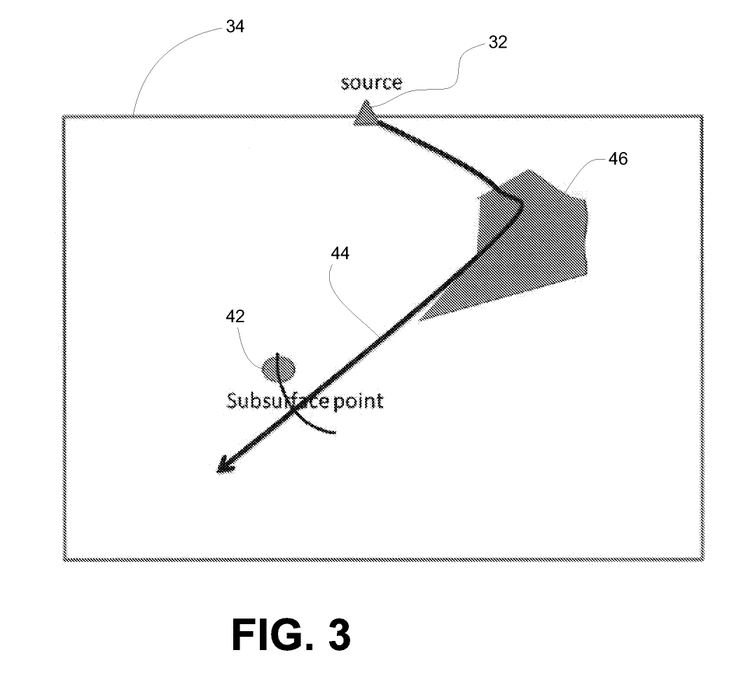

FIG. 3, on the other hand illustrates a body of energy 44 that propagates from source 32 to coarse meshpoint 42, but has a propagation history that is substantially different from those of bodies of energy 36, 38, and 40 (shown in FIG. 2 and described above). Rather than propagating along a relatively straight center ray path, the center ray path of body of energy 44 passes through a region 46 within geologic volume of interest 34 that has a different composition than the rest of geologic volume of interest 34. Rather than passing directly through region 46, body of energy 44 is refracted by region 46, and travels in a somewhat circuitous path to coarse meshpoint 42.

By virtue of this relatively indirect path, body of energy 44 would have properties somewhat different than bodies of energy 36, 38, and 40 (shown in FIG. 2 and described above). As such, in one embodiment, the arrival of body of energy 44 at coarse meshpoint 42 would be included in a cluster of arrivals at coarse meshpoint 42 that is separate from the cluster of arrivals that includes bodies of energy 36, 38, and 40 (shown in FIG. 2 and described above). The cluster of arrivals including the arrival of region 46 at coarse meshpoint 42 may include one or more other arrivals (not shown), or the cluster of arrivals may include only the arrival of region 46 at coarse meshpoint 42.

Returning to FIG. 1, in one embodiment, cluster module 26 forms arrivals at individual coarse meshpoints into clusters of arrivals at the individual coarse meshpoints based on an analysis of traveltime and/or spatial derivatives thereof. Arrivals of seismic traveltime at a given coarse meshpoint are grouped into clusters of arrivals for the given coarse meshpoint by grouping the arrivals with similar traveltimes and/or spatial derivatives of traveltimes together. This is not intended to be limiting, as other basis of separating arrivals of seismic energy into clusters may be implemented without departing from the scope of this disclosure.

In one embodiment, one or more aspects of the grouping of arrivals of seismic energy into clusters are configurable by a user (e.g., via inputs to user interface 14). By way of non-limiting example, based on user selection, cluster module 26 may set a maximum quantity of clusters per coarse meshpoint, a minimum quantity of clusters per coarse meshpoint, and/or an absolute quantity of clusters per meshpoint. As another example, based on user selection cluster module 26 may set the parameters of arrivals of seismic energy that will be analyzed to group the clusters into arrivals. Other aspects of the grouping of arrivals of seismic energy into clusters may be configurable by the user.

It will be appreciated that although the grouping of arrivals at coarse meshpoints into clusters has been described in the context of creating a plurality clusters at individual meshpoints, this is not intended to be limiting. In one embodiment, cluster module 26 creates a single cluster of arrivals at each coarse meshpoint (or cluster module 26 is not included and all of the arrivals at each coarse meshpoint are simply considered to be included in a single group, or cluster, in subsequent processing).

Characteristic arrival module 27 is configured to determine characteristic bodies of seismic energy for the arrivals within the individual clusters. In an embodiment in which the bodies of seismic energy are modeled as beams, the characteristic body of seismic energy for a given cluster of arrivals at a given coarse meshpoint is a characteristic beam of seismic energy arriving at the given coarse meshpoint. In one embodiment, the characteristic beam is determined by averaging the beam parameters of all of the beam arrivals at the given coarse meshpoint in the given cluster. This average may be weighted or unweighted. As a non-limiting example of a weighted average, the traveltime, amplitude, and/or propagation path of the individual beam arrivals may be used to weight the parameters of the individual beam arrivals for averaging. For instance, in one embodiment, characteristic arrival module 27 identifies the beam arrival with the minimum imaginary traveltime. The weight applied to the beam parameters of a given beam arrival used in determining a weighted average of beam parameters for the arrival cluster is then determined by characteristic arrival module 27 as the cosine function of the propagation angle difference between the beam arrival having the minimum imaginary traveltime and the given beam arrival.

In one embodiment, rather than averaging the beam arrivals within the given cluster to determine the characteristic beam, characteristic arrival module 27 simply selects one of the beam arrivals as the characteristic beam. By way of non-limiting example, characteristic arrival module 27 may select the beam arrival with the minimum imaginary traveltime, the beam arrival with the highest amplitude, and/or the beam satisfying some other criteria.

The aggregation module 28 is configured to aggregate arrivals within clusters. This aggregation results in aggregated data for individual clusters. The aggregated data for a given cluster is usable in subsequent imaging such that image processing can be performed for the cluster as a whole based on the aggregated data, rather than individually performing image processing for each arrival in the given cluster. The aggregated data for the given cluster reflects each of the individual arrivals of seismic energy in the given cluster, and is not merely a selection of a single arrival from the cluster.

In one embodiment, to aggregate arrivals within clusters, aggregation module 28 determines aggregation data for the clusters by shifting, scaling, and summing seismic data traces associated with the beam arrivals in the clusters. In this embodiment, to determine aggregation data for a given cluster of arrivals at a given coarse meshpoint, aggregation module 28 obtains the seismic data traces associated with the arrivals of seismic energy at the given coarse meshpoint that have been grouped into the given cluster. The aggregation module 28 may obtain these seismic data traces from data module 22.

To shift the seismic data traces associated with the obtained arrivals of seismic energy, aggregation module 28 compares the traveltimes of the individual arrivals of seismic energy at the given coarse meshpoint with the traveltime of the characteristic beam for the given cluster. Specifically, the seismic data trace (or traces) associated with a first arrival that is included in the given cluster is time shifted by a first time shift, and the seismic data trace (or traces) associated with a second arrival in the given cluster is shifted by a second time shift. The first time shift is determined based on a time difference between the traveltime of the first arrival at the given coarse meshpoint and the traveltime of the characteristic beam arrival at the given coarse meshpoint. In one embodiment, the first time shift is the time difference between the traveltime of the first arrival at the given coarse meshpoint and the traveltime of the characteristic beam arrival. The second time shift is determined based on a time difference between the traveltime of the second arrival at the given coarse meshpoint and the traveltime of the characteristic beam arrival at the given coarse meshpoint.

To scale the seismic data traces associated with the obtained arrivals of seismic energy, aggregation module 28 uses the amplitudes and/or imaginary traveltimes of the arrivals of seismic energy. The imaginary traveltimes are used in an exponential function in the frequency domain to get scale values. These scale values and the amplitudes are then used to multiply the related data traces within the finite time window defined by coarse meshpoint spacing, arrival traveltimes and spatial derivatives of arrival traveltime.

Once the seismic data traces associated with the arrivals of the given cluster at the given coarse meshpoint have been shifted and/or scaled, aggregation module 28 sums shifted and/or scaled traces such that the given cluster is associated with a single channel of seismic data representing the shifted, scaled, and/or summed seismic data traces. This single channel of seismic data representing the shifted, scaled, and/or summed seismic data traces associated with the given cluster of arrivals at the given meshpoint is then implemented in image processing (e.g., as described below with respect to image module 30).

In one embodiment, aggregation module 28 does not generate aggregated data for the clusters by summing individual seismic data traces. In this embodiment, aggregation module 28 determines aggregated wavelets corresponding to the individual clusters, which can then be implemented as a wavefield described by the wavelets.

By way of non-limiting example, in an embodiment in which the seismic energy is modeled as beams of seismic energy, each beam arrival at a given coarse meshpoint within a given cluster has beam parameters determined by arrival module 24. These beam parameters may include traveltime, amplitude and propagation direction. For a band limited source wavelet (corresponding to the actual position and/or orientation of the source of seismic energy at the time of acquisition) and the given coarse meshpoint, each of the beam arrivals in the given cluster can be expressed as a short wavelet centered around beam traveltime. The short wavelet has its own center arrivaltime, amplitude, phase, and/or other parameters. The short wavelets expressing the beam arrivals in the given cluster are then aggregated into a cluster wavelet at the given coarse meshpoint. The aggregation of the wavelets may include summing the wavelets. The summing may be weighted or unweighted. As one non-limiting example, the weight can be computed as the cosine function of propagation angle differences of each individual arrival and the characteristic arrival. This weight value is used to scale the wavelet by mulitiplying. The wavelets can then be implemented in subsequent image processing (e.g., as described below with respect to image module 30).

The image module 30 is configured to implement aggregated data generated by image module 30 for the clusters of arrivals at the coarse meshpoints to image the geologic volume of interest. Imaging the geologic volume of interest includes extending the aggregated data at the coarse meshpoints to image the fine meshpoints within the geologic volume of interest.

As was discussed above, image module 30 may generate aggregated data for the clusters by shifting, scaling, and/or summing seismic data traces associated with the arrivals of seismic energy in the clusters. This generates, for individual clusters, a corresponding single channel of seismic data representing the shifted, scaled, and/or summed seismic data traces associated with the corresponding individual cluster. In one embodiment, image module 30 implements this aggregated seismic data by applying the shifted, scaled, and/or summed seismic data corresponding to a given cluster of arrivals at a given coarse meshpoint to image on fine meshpoints surrounding the given coarse meshpoint. To apply the shifted, scaled, and/or summed seismic data to imaging on the fine meshpoints, image module 30 uses the beam properties (and/or the spatial and/or time derivatives thereof) of the characteristic beam arrival determined for the given cluster at the given coarse meshpoint by characteristic arrival module 27. As will be appreciated, this enables all of the summed traces of seismic data to be applied to an imaging process surrounding the given coarse meshpoint in a single imaging process, rather than individual imaging processes for each of the traces.

As was discussed above, aggregation module 28 may generate aggregated data for clusters of arrivals at coarse meshpoints by determining wavelets that correspond to individual clusters at the coarse meshpoints. In one embodiment, image module 30 implements the wavelets corresponding to the individual clusters of arrivals at the coarse meshpoints to image the geologic volume of interest. To accomplish this, image module 30 stacks the wavelets corresponding to the individual clusters in order to derive the wavefield at the coarse meshpoints, and, from seismic data traces obtained from data module 22 and the wavefield, forms image traces that can be extended to fine meshpoints surrounding the coarse meshpoints.

For example, at a given coarse meshpoint, image module 30 cross-correlates the stacked cluster wavelets with a seismic data trace to derive an image trace at the given coarse meshpoint. The image module 30 then obtains a seismic data trace through the given coarse meshpoint and implements the cross-correlated cluster wavelets to derive an image trace from the seismic data trace. This may be repeated for a plurality of obtained seismic data traces through the given coarse meshpoint.

To image the fine meshpoints around the given coarse meshpoint, the image trace(s) through the given coarse meshpoint are extended. The image trace(s) may be extended to the fine meshpoints by the spatial derivatives traveltime of the characteristic arrival determined for the given coarse meshpoint by characteristic arrival module 27.

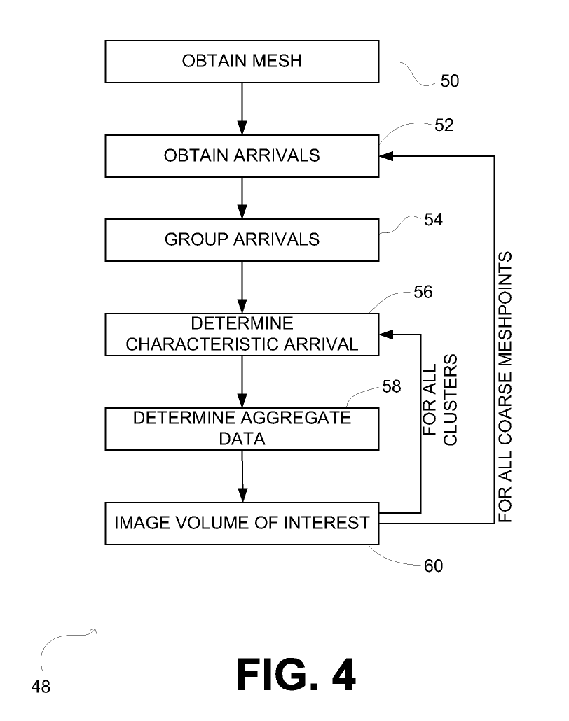

FIG. 4 illustrates a method 48 of processing seismic data in order to obtain an image of a geologic volume of interest, according to one or more embodiments of the invention. The operations of method 48 presented below are intended to be illustrative. In some embodiments, method 48 may be accomplished with one or more additional operations not described, and/or without one or more of the operations discussed. Additionally, the order in which the operations of method 48 are illustrated in FIG. 4 and described below is not intended to be limiting.

In some embodiments, method 48 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 48 in response to instructions stored electronically on an electronic storage medium. The one or more processing devices may include one or more devices configured through hardware, firmware, and/or software to be specifically designed for execution of one or more of the operations of method 48.

At an operation 50, a mesh through a geologic volume of interest is obtained. Obtaining the mesh through the geologic volume of interest includes obtaining locations of a plurality of coarse meshpoints and a plurality of fine meshpoints within the geologic volume of interest. In one embodiment, operation 50 is performed by a mesh module that is the same as or similar to mesh module 20 (shown in FIG. 1 and described above).

At an operation 52, arrivals of seismic energy at a given coarse meshpoint are obtained. Obtaining the arrivals at the given meshpoint includes obtaining one or more parameters describing properties of the arrivals at the given meshpoint. For example, the arrivals of seismic energy may be modeled as beams, such as Gaussian beams, and the parameters may include beam parameters of the beams. In one embodiment, operation 52 is performed by an arrival module that is the same as or similar to arrival module 24 (shown in FIG. 1 and described above).

At an operation 54 the arrivals of seismic energy at the given coarse meshpoint are grouped into one or more clusters. The arrivals of seismic energy are grouped into the one or more clusters based on similarities in parameters obtained at operation 52 and/or properties described by the obtained parameters. The grouping of arrivals of seismic energy into one or more clusters may be based in part on one or more user inputs (e.g., maximum clusters, minimum clusters, defined number of clusters, etc.). In one embodiment, operation 54 is performed by a cluster module that is the same as or similar to cluster module 26 (shown in FIG. 1 and described above).

At an operation 56, a characteristic arrival is determined for a given cluster of arrivals at the given coarse meshpoint. The characteristic arrival is determined from the parameters obtained for the arrivals of seismic energy within the given cluster of arrivals. By way of non-limiting example, the parameters of the arrivals of seismic energy within the given cluster of arrivals may be averaged to determine parameters of the characteristic arrival. This average may be weighted or unweighted. As another non-limiting example, one of the arrivals within the cluster of arrivals may be selected as the characteristic arrival. In one embodiment, operation 56 may be performed by a characteristic arrival module that is the same as or similar to characteristic arrival module 27 (shown in FIG. 1 and described above).

At an operation 58, aggregate data for the given cluster of arrivals at the given coarse meshpoint is determined The aggregate data for the given cluster enables unified imaging processing at the given coarse meshpoint that accounts for all of the arrivals of seismic energy within the given cluster of arrivals. In other words, from the aggregate data for the given cluster, image processing is performed that does not account for the individual arrivals within the given cluster of arrivals. Instead, in the subsequent image processing the aggregate data is used in proxy for the individual arrivals within the given cluster of arrivals. In one embodiment, operation 58 is performed by an aggregation module that is the same as or similar to aggregation module 28 (shown in FIG. 1 and described above).

At an operation 60, the geologic volume of interest is imaged at the given meshpoint, and at the fine meshpoints surrounding the given meshpoint. This imaging is not performed by separate imaging processes extending image information associated with individual arrivals at the given coarse meshpoint to the fine meshpoints. Instead, the imaging performed by operation 60 leverages the aggregated data obtained for the clusters of arrivals at the given coarse meshpoint to reduce the amount of processing required to derive the image information at the fine meshpoints.

In one embodiment, method 48 loops back over operations 56, 58, and 60 for all of the clusters of arrivals at the given meshpoint created by operation 54. In one embodiment, once operations 56 58, and 60 for all of the clusters of arrivals at the given meshpoint, method 48 loops over operations 52, 54, 56, 58, and 60 for each of the coarse meshpoints obtained at operation 50. The result is that an image of the geologic volume of interest is formed.

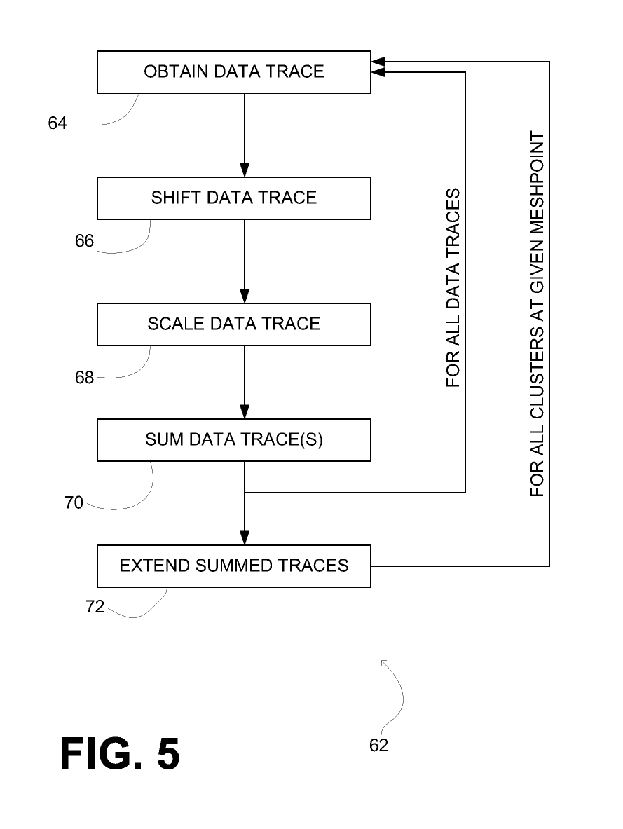

FIG. 5 illustrates a method 62 of processing seismic data in order to obtain an image of a geologic volume of interest, according to one or more embodiments of the invention. The operations of method 62 presented below are intended to be illustrative. In some embodiments, method 62 may be accomplished with one or more additional operations not described, and/or without one or more of the operations discussed. Additionally, the order in which the operations of method 62 are illustrated in FIG. 5 and described below is not intended to be limiting.

In some embodiments, method 62 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 62 in response to instructions stored electronically on an electronic storage medium. The one or more processing devices may include one or more devices configured through hardware, firmware, and/or software to be specifically designed for execution of one or more of the operations of method 62.

In one embodiment, method 62 is implemented within an over-arching method that is the same as or similar to method 48 (shown in FIG. 4 and described above). Specifically, method 62 may be implemented as operations 54 and 56 within method 48 in FIG. 4.

Referring specifically to FIG. 5, at an operation 64, for a given coarse meshpoint, and for a given cluster of arrivals at the given coarse meshpoint, a seismic data trace is obtained. The seismic data trace is through the given coarse meshpoint. In one embodiment, operation 64 may be performed by an aggregation module that is the same as or similar to aggregation module 28 (shown in FIG. 1 and described above).

At an operation 66, the seismic data trace obtained at operation 66 is time shifted. The seismic data trace is time shifted based on time differences between the traveltimes of the arrivals in the given cluster of arrivals and the traveltime of a characteristic arrival of the given cluster of arrivals (e.g., previously determined as described above with respect to operation of 42 of method 48, shown in FIG. 4). In one embodiment, operation 66 is performed by an aggregation module that is the same as or similar to aggregation module 28 (shown in FIG. 1 and described above).

At an operation 68, the seismic data trace is scaled. The seismic data trace may be scaled based on the amplitude of the arrivals from the given cluster of arrivals at the given meshpoint. This scaling may be absolute, or based on a relative comparison of the arrivals in the given cluster of arrivals and/or the characteristic arrival for the given cluster of arrivals. In one embodiment, operation 68 is performed by an aggregation module that is the same as or similar to aggregation module 28 (shown in FIG. 1 and described above).

At an operation 70, the shifted and/or scaled seismic data trace is summed (e.g., with previously processed seismic data traces). This sum may be weighted or unweighted. In one embodiment, operation 70 is performed by an aggregation module that is the same as or similar to aggregation module 28 (shown in FIG. 1 and described above).

Method 62 then loops back over operations 64, 66, 68, and 70. Once method 62 has looped back over operations 64, 66, 68, and 70 for all of the appropriate seismic data traces, the summing of the seismic data trace at operation 70 results in a single channel of seismic data that accounts for all of the arrivals within the given cluster of arrivals at the given coarse meshpoint. This single channel of seismic data is the aggregation data for the given cluster at the given meshpoint.

At an operation 72, the aggregated data for the given cluster of arrivals at the given coarse meshpoint is extended to fine meshpoints around the given coarse meshpoint to image the fine meshpoints. To extend the aggregated data for the given cluster of arrivals at the given coarse meshpoint, the characteristic arrival for the given cluster of arrivals, the beam parameters of the characteristic arrival, and/or the spatial derivative of traveltime of the characteristic arrival are used.

Method 62 then loops back over all of the clusters at the given coarse meshpoint. The result is an image of the given coarse meshpoint and the surrounding fine meshpoints. As part of a larger, over-arching method (e.g., method 48 of FIG. 4), method 62 may be looped over again for each of the given coarse meshpoints to image fine meshpoints throughout the geologic volume of interest.

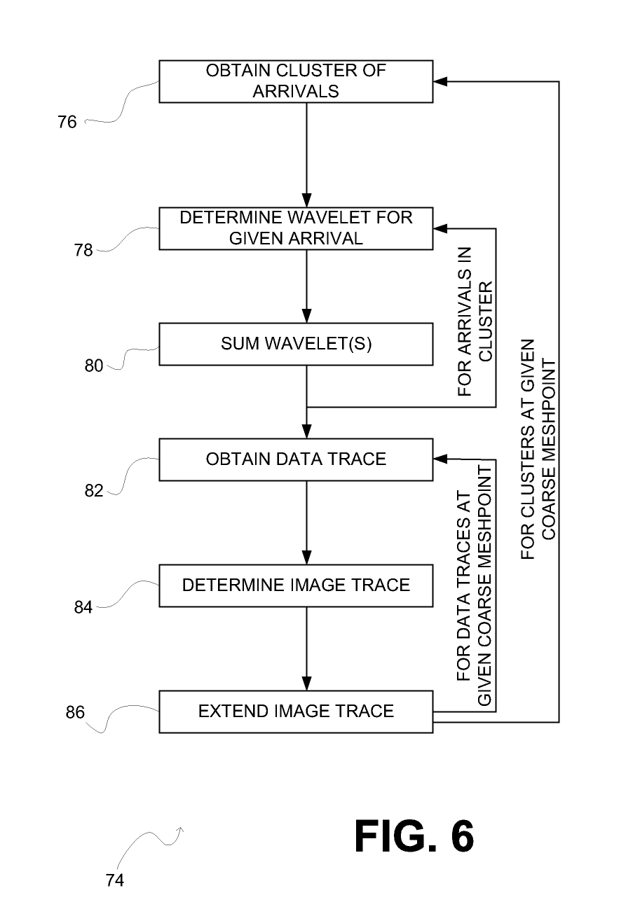

FIG. 6 illustrates a method 74 of processing seismic data in order to obtain an image of a geologic volume of interest, according to one or more embodiments of the invention. The operations of method 74 presented below are intended to be illustrative. In some embodiments, method 74 may be accomplished with one or more additional operations not described, and/or without one or more of the operations discussed. Additionally, the order in which the operations of method 74 are illustrated in FIG. 6 and described below is not intended to be limiting.

In some embodiments, method 74 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 74 in response to instructions stored electronically on an electronic storage medium. The one or more processing devices may include one or more devices configured through hardware, firmware, and/or software to be specifically designed for execution of one or more of the operations of method 74.

In one embodiment, method 74 is implemented within an over-arching method that is the same as or similar to method 48 (shown in FIG. 4 and described above). Specifically, method 74 may be implemented as operations 54 and 54 within method 48 in FIG. 4.

Referring specifically to FIG. 6, at an operation 76, a cluster of arrivals of seismic energy at a given coarse meshpoint in a geologic volume of interest are obtained. Obtaining the cluster of arrivals may include obtaining the beam parameters of the individual arrivals in the cluster of arrivals, and/or a characteristic arrival that has been previously determined for the cluster arrivals. In one embodiment, operation 76 is performed by an aggregation module that is the same as or similar to aggregation module 28 (shown in FIG. 1 and described above).

At an operation 78, for a given arrival within the cluster of arrivals obtained at operation 76, a wavelet centered around the given coarse meshpoint is determined The wavelet is a source wavelet determined from the parameters of the given arrival. In one embodiment, operation 78 is performed by an aggregation module that is the same as or similar to aggregation module 28 (shown in FIG. 1 and described above).

At an operation 80, the wavelet determined for the given arrival at the given coarse meshpoint is stacked with other wavelets determined from arrivals in the cluster of arrivals obtained at operation 76. In one embodiment, operation 80 is performed by an aggregation module that is the same as or similar to aggregation module 28 (shown in FIG. 1 and described above).

Method 74 loops over operations 78 and 80 for all of the arrivals in the cluster of arrivals at the given coarse meshpoint obtained at operation 76. The result is a stacked wavelet at the given coarse meshpoint for the cluster of arrivals at the given coarse meshpoint. This stacked wavelet constitutes aggregated data for the cluster of arrivals at the given coarse meshpoint. That is, subsequent image processing implements the stacked wavelet without referring back to the arrivals of seismic energy in the cluster of arrivals individually.

At an operation 82, an seismic data trace for the given coarse meshpoint is obtained. The seismic data trace may be a “raw” trace of seismic data, or may have been processed previously (e.g., slant stacked and/or beam weighted). In one embodiment, operation 82 is performed by a data module that is the same as or similar to data module 22 (shown in FIG. 1 and described above).

At an operation 84, the stacked wavelet determined at operation 80 and the seismic data trace obtained at operation 82 are implemented to determine an image trace for the given coarse meshpoint. For example, the stacked wavelet may be cross-correlated with the seismic data trace to determine the image trace. In one embodiment, operation 84 is performed by an image module that is the same as or similar to image module 30 (shown in FIG. 1 and described above).

In one embodiment, instead of stacking wavelets in operation 80 above, each wavelet can be cross-correlated with one related data trace to form one image trace. For each wavelet the related data trace can be the same one or can be different. For a number of wavelets described with respect to operation 78, a number of image traces can be created. These image traces can then be stacked together to form a single image trace which can be used in subsequent steps.

At an operation 86, the image trace determined at operation 84 is extended to fine meshpoints surrounding the given coarse meshpoint. To extend the image trace to the fine meshpoints, the parameters of the characteristic arrival of the cluster of arrivals, and/or the spatial derivatives of traveltime of the characteristic arrival, are implemented. In one embodiment, operation 86 is performed by an image module that is the same as or similar to image module 30 (shown in FIG. 1 and described above).

Once the image trace has been extended to the fine meshpoints surrounding the given coarse meshpoint, method 74 loops over operations 82, 84, and 86 for all of the seismic data traces available for the given coarse meshpoint. This results in the determination of a plurality of image traces (where a plurality of seismic data traces are available) that are extended to image the fine meshpoints surrounding the given coarse meshpoint.

After operations 82, 84, and 86 have been looped for all of the available seismic data traces, operations 76, 78, 80, 82, 84, and 86 are looped for any other clusters of arrivals existing for the given coarse meshpoint. In one embodiment, after operations 76, 78, 80, 82, 84, and 86 are looped for the clusters of arrivals at the given coarse meshpoint, method 74 may be looped again for a plurality of coarse meshpoints within the geologic volume of interest. Looping method for the plurality of coarse meshpoints may be part of an over-arching method (e.g., method 48 shown in FIG. 4 and described above).

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A system configured to process seismic data associated with a geologic volume of interest, the system comprising:
electronic storage configured to store information representative of seismic energy propagated through the geologic volume of interest from one or more energy sources to one or more energy receivers at or near the geologic volume of interest; and
one or more processors configured to execute a plurality of computer program modules, the computer program modules comprising:
an arrival module configured to obtain one or more parameters of a plurality of arrivals of seismic energy at coarse meshpoints located within the geologic volume of interest, such that for individual coarse meshpoints, parameters for corresponding sets of arrivals of seismic energy are obtained,
wherein the coarse meshpoints within the geologic volume of interest comprise a first meshpoint, and wherein the arrival module is configured to obtain one or more parameters for arrivals of seismic energy at the first meshpoint;
a cluster module configured to group arrivals of seismic energy at the coarse meshpoints into clusters of arrivals for the coarse meshpoints, wherein the clusters of arrivals include a first cluster of arrivals including one or more of the arrivals of seismic energy at the first meshpoint, and a second cluster of arrivals including one or more of the arrivals of seismic energy at the first meshpoint;
an aggregation module configured to determine aggregated data for individual ones of the clusters of arrivals such that the aggregated data for the first cluster of arrivals reflects parameters of each of the arrivals of seismic energy at the first meshpoint included in the first cluster of arrivals, and such that the aggregated data for the second cluster of arrivals reflects parameters of each of the arrivals of seismic energy at the first meshpoint included in the second cluster of arrivals; and
an image module configured to implement the aggregated data for the clusters of arrivals to image the geologic volume of interest at fine meshpoints surrounding the coarse meshpoints,
wherein the image module is configured to implement the aggregated data for the first cluster of arrivals and the aggregated data for the second cluster of arrivals to image the geologic volume of interest at fine meshpoints surrounding the first meshpoint.

2. The system of claim 1, wherein the arrivals of seismic energy are modeled as beams, and wherein the arrival module is configured to obtain beam parameters of the individual arrivals of seismic energy at the coarse meshpoints within the geologic volume of interest.

3. The system of claim 1, further comprising a characteristic arrival module configured to determine characteristic arrivals corresponding to the individual clusters of arrivals of seismic energy, wherein determining a characteristic arrival comprises determining parameters of the characteristic arrival.

4. The system of claim 3, wherein the aggregation module is configured:
to implement parameters of a characteristic arrival determined for the first cluster of arrivals of seismic energy by the characteristic arrival module to determine the aggregated data for the first cluster of arrivals of seismic energy, and
to implement parameters of a characteristic arrival determined for the second cluster of arrivals of seismic energy by the characteristic arrival module to determine aggregated data for the second cluster of arrivals of seismic energy.

5. The system of claim 3, wherein the image module is configured:
to implement (i) parameters of a characteristic arrival determined for the first cluster of arrivals of seismic energy by the characteristic arrival module, and (ii) the aggregated data for the first cluster of arrivals of seismic energy to image the geologic volume of interest at fine meshpoints surrounding the first meshpoint, and
to implement (i) parameters of a characteristic arrival determined for the second cluster of arrivals of seismic energy by the characteristic arrival module, and (ii) the aggregated data for the second cluster of arrivals of seismic energy to image the geologic volume of interest at the fine meshpoints surrounding the first meshpoint.

6. A computer-implemented method of processing seismic data associated with a geologic volume of interest, wherein the method is implemented in a computer system comprising one or more processors configured to execute one or more computer program modules, the method comprising:
storing, to electronic storage accessible to the one or more processors, information representative of seismic energy propagated through the geologic volume of interest from one or more energy sources to one or more energy receivers at or near the geologic volume of interest;
obtaining, on the one or more processors, one or more parameters of a plurality of arrivals of seismic energy at coarse meshpoints located within the geologic volume of interest, such that for individual coarse meshpoints, parameters for corresponding sets of arrivals of seismic energy are obtained,
wherein the coarse meshpoints within the geologic volume of interest comprise a first meshpoint, and wherein one or more parameters for arrivals of seismic energy at the first meshpoint are obtained;
grouping, on the one or more processors, arrivals of seismic energy at the coarse meshpoints into clusters of arrivals for the coarse meshpoints, wherein the clusters of arrivals include a first cluster of arrivals including one or more of the arrivals of seismic energy at the first meshpoint, and a second cluster of arrivals including one or more of the arrivals of seismic energy at the first meshpoint;
determining, on the one or more processors, aggregated data for individual ones of the clusters of arrivals such that the aggregated data for the first cluster of arrivals reflects parameters of each of the arrivals of seismic energy at the first meshpoint included in the first cluster of arrivals, and such that the aggregated data for the second cluster of arrivals reflects parameters of each of the arrivals of seismic energy at the first meshpoint included in the second cluster of arrivals; and
implementing, on the one or more processors, the aggregated data for the clusters of arrivals to image the geologic volume of interest at fine meshpoints surrounding the coarse meshpoints,
wherein the aggregated data for the first cluster of arrivals and the aggregated data for the second cluster of arrivals are implemented to image the geologic volume of interest at fine meshpoints surrounding the first meshpoint.

7. The method of claim 6, wherein the arrivals of seismic energy are modeled as beams, and wherein obtaining the arrivals of seismic energy comprises obtaining beam parameters of the individual arrivals of seismic energy at the coarse meshpoints within the geologic volume of interest.

8. The method of claim 6, further comprising determining, on the one or more processors, characteristic arrivals corresponding to the individual clusters of arrivals of seismic energy, wherein determining a characteristic arrival comprises determining parameters of the characteristic arrival.

9. The method of claim 8, wherein the determination of the aggregated data for the first cluster of arrivals of seismic energy is based on parameters of a characteristic arrival determined for the first cluster of arrivals of seismic energy, and wherein the determination of the aggregated data for the second cluster of arrivals of seismic energy is based on parameters of a characteristic arrival determined for the second cluster of arrivals of seismic energy.

10. The method of claim 8, wherein imaging the geologic volume of interest at fine meshpoints surrounding the first meshpoint comprises:
implementing, on the one or more processors, (i) parameters of a characteristic arrival determined for the first cluster of arrivals of seismic energy, and (ii) the aggregated data for the first cluster of arrivals of seismic energy to image the geologic volume of interest at fine meshpoints surrounding the first meshpoint, and
implementing, on the one or more processors, (i) parameters of a characteristic arrival determined for the second cluster of arrivals of seismic energy, and (ii) the aggregated data for the second cluster of arrivals of seismic energy to image the geologic volume of interest at the fine meshpoints surrounding the first meshpoint.

11. A computer-implemented method of processing seismic data associated with a geologic volume of interest, wherein the method is implemented in a computer system comprising one or more processors configured to execute one or more computer program modules, the method comprising:
storing, to electronic storage accessible to the one or more processors, information representative of seismic energy propagated through the geologic volume of interest from one or more energy sources to one or more energy receivers at or near the geologic volume of interest;
obtaining, on the one or more processors, one or more parameters of a plurality of arrivals of seismic energy at coarse meshpoints located within the geologic volume of interest, such that for individual coarse meshpoints, parameters for corresponding sets of arrivals of seismic energy are obtained,
wherein the coarse meshpoints within the geologic volume of interest comprise a first meshpoint and a second meshpoint, wherein one or more parameters for arrivals of seismic energy at the first meshpoint are obtained, and wherein one or more parameters for arrivals of seismic energy at the second meshpoint are obtained;
determining, on the one or more processors, aggregated data for arrivals at the coarse meshpoints such that the aggregated data for the arrivals of seismic energy at the first meshpoint reflects the parameters of each of the arrivals of seismic energy at the first meshpoint, and such that the aggregated data for the arrivals of seismic energy at the second meshpoint reflects the parameters of each of the arrivals of seismic energy at the second meshpoint; and
implementing, on the one or more processors, the aggregated data for the clusters of arrivals to image the geologic volume of interest at fine meshpoints surrounding the coarse meshpoints,
wherein the aggregated data for the arrivals of seismic energy at the first meshpoint are implemented to image the geologic volume of interest at fine meshpoints surrounding the first meshpoint, and wherein the aggregated data for the arrivals of seismic energy at the second meshpoint are implemented to image the geologic volume of interest at fine meshpoints surrounding the second meshpoint.

12. The method of claim 11, wherein the arrivals of seismic energy are modeled as beams, and wherein obtaining the arrivals of seismic energy comprises obtaining beam parameters of the individual arrivals of seismic energy at the coarse meshpoints within the geologic volume of interest.

13. The method of claim 11, further comprising determining, on the one or more processors, characteristic arrivals corresponding to the arrivals of seismic energy at the coarse meshpoints, wherein determining a characteristic arrival comprises determining parameters of the characteristic arrival.

14. The method of claim 13, wherein the determination of the aggregated data for the arrivals of seismic energy at the first meshpoint is based on parameters of a characteristic arrival determined for the arrivals of seismic energy at the first meshpoint, and wherein the determination of the aggregated data for the arrivals of seismic energy at the second meshpoint is based on parameters of a characteristic arrival determined for the arrivals of seismic energy at the second meshpoint.

15. The method of claim 8, wherein imaging the geologic volume of interest at fine meshpoints surrounding the coarse meshpoints comprises:
implementing, on the one or more processors, (i) parameters of a characteristic arrival determined for the arrivals of seismic energy at the first meshpoint, and (ii) the aggregated data for the arrivals of seismic energy at the first meshpoint to image the geologic volume of interest at fine meshpoints surrounding the first meshpoint, and
implementing, on the one or more processors, (i) parameters of a characteristic arrival determined for the arrivals of seismic energy at the second meshpoint, and (ii) the aggregated data for the arrivals of seismic energy at the second meshpoint to image the geologic volume of interest at the fine meshpoints surrounding the second meshpoint.
